(19) United States
(12) Patent Application Publication
(10) Pub. No.: US 2019/0039415 A1
(43) Pub. Date: Feb. 7, 2019

(54) ELASTOMERIC ARTICLES AS WELL AS DEVICES INCLUDING SAME AND METHODS OF MANUFACTURE

(71) Applicant: Firestone Industrial Products Company, LLC, Nashville, TN (US)

(72) Inventor: Jason B. Smith, Fairview, TN (US)

(21) Appl. No.: 16/072,573

(22) PCT Filed: Jan. 29, 2017
(86) PCT No.: PCT/US17/15526

§ 371 Date: Jul. 25, 2018

Related U.S. Application Data
(60) Provisional application No. 62/288,839, filed on Jan. 29, 2016.

(51) Int. Cl. B60C 9/00; B60C 9/12

(52) U.S. Cl. CPC B60C 9/0057; B60C 2009/0491; B60C 9/12

(57) ABSTRACT

An elastomeric article can include an elastomeric body that is at least partially formed from an elastomeric material. The elastomeric body can include a first surface portion and a second surface portion facing opposite the first surface portion. A first plurality of reinforcing elements can be embedded within the elastomeric body between the first and second surface portions. The first plurality of reinforcing elements can have a first end and a second end opposite the first end with the first plurality of reinforcing elements having a non-linear pattern formed therealong between the first and second ends thereof. As examples, the elastomeric article can at least partially form one of pneumatic or non-pneumatic tire, a flexible spring member of a gas spring assembly and/or a turnup bladder dimensioned for securement on an associated tire building machine. Methods of manufacturing an elastomeric articles are also included.

### BACKGROUND

The subject matter of the present disclosure broadly relates to the art of elastomeric articles and, more particularly, to filament reinforced elastomeric articles having an increased range of elastomeric elongation as compared with conventional constructions. A wide range of devices and constructions can include one or more of such elastomeric articles, such as vehicles with tires and/or gas spring assemblies and tire manufacturing equipment, for example. Methods of manufacturing such elastomeric articles are also included.

The subject matter of the present disclosure may find particular application and use in conjunction with the manufacture and/or use of components for wheeled vehicles, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with gas spring assemblies of non-wheeled vehicles as well as support structures, height adjusting systems and actuators associated with industrial machinery, components thereof and/or other such equipment. Accordingly, the subject matter of the present disclosure is not intended to be limited to use in association with the manufacture and/or use of components of wheeled vehicles.

Elastomeric articles of a wide variety of types and kinds are well known and commonly used in a wide variety of applications and environments. For example, elastomeric articles in the form of pneumatic and non-pneumatic tires are commonly used on a wide variety of motorized and non-motorized vehicles. As another example, flexible spring members are commonly used to construct gas spring assemblies that utilize pressurized gas to support loads and transmit forces to and from components between which the gas spring assemblies are installed. As a further example, flexible bladders are commonly used in connection with the manufacture of elastomeric articles, such as tires, for example.

In many cases, such elastomeric articles are subjected to repeated expansion and contraction or other types of flexing during use. In some cases, such expansion and contraction can be due to the transfer of pressurized gas or other fluids into and out of an elastomeric article. Additionally, or in the alternative, an elastomeric article may experience forces or loads that at least partially cause the elastomeric article to expand and contract or otherwise flex. For example, a portion of an elastomeric article may undergo centrifugal displacement as a result of rotation of the elastomeric article, such as the spinning of a tire, for example.

Elastomeric materials are capable of withstanding elongation within a range of from twenty five (25) percent to five hundred (500) percent or more, and different materials with different elongation properties may be selected for a particular application depending upon a wide variety of other criteria other than the elongation or elastic limit of the elastomeric material. To assist in controlling the expansion, contraction and/or other flexing of elastomeric material from which the elastomeric article is formed, a plurality of reinforcing elements or cords are commonly embedded within the elastomeric material of the elastomeric article. Such elements or cords are typically formed from materials that have substantially lower elastic limit in comparison with elastomeric materials. The materials from which the reinforcing elements or cords are commonly formed normally have an elastic limit of less than ten (10) percent and often substantially less than five (5) percent. Non-limiting examples of such materials can include natural materials, such as cotton yarn, as well as semi-synthetic materials, such as rayon, and/or polymeric materials, such as polyester, polyamide and aramid.

The amount and direction in which elastomeric articles can expand, elongate or otherwise deform under the influence of pressurized gas and/or other load conditions depends on a variety of factors including the material properties of the elastomeric material, the material properties of the reinforcing filaments or cords and the orientation of the reinforcing filaments or cords within the elastomeric material. In known constructions, multiple reinforcing filaments or cords are arranged next to one another and extend in a substantially linear configuration for encapsulation or at least partial coating by an elastomeric material. This process is commonly referred to as calendaring, and results in the generation of rolls of reinforcing material in which the reinforcing cords are arranged next to one another in a substantially linear, parallel orientation. In known constructions, sections of such reinforcing material are embedded within two or more layers of elastomeric material for form the elastomeric article.

In some cases, it may be desirable for an elastomeric article to be capable of expansion or extension in a particular direction. Generally, the elastomeric material from which the article is formed will be capable of undergoing such displacement. In many cases, however, the expansion or extension in a particular direction will be substantially controlled by the orientation of the reinforcing filaments or cords embedded within the elastomeric material and the amount of stretch that the reinforcing filaments or cords are capable of undergoing. As such, elastomeric articles having known constructions may be undesirably limited with regard to expansion and/or extension capabilities thereof. Additionally, the performance capabilities of elastomeric materials used in known constructions may be being underutilized.

In view of the foregoing and notwithstanding the overall success of known constructions of elastomeric articles, it is believed that the foregoing and/or other disadvantages of conventional constructions exist and that a need remains to meet the aforementioned competing goals while still retaining comparable or improved performance and other desired features. Accordingly, it is believed desirable to develop constructions and method of manufacture that overcome the foregoing and/or other problems and/or disadvantages of known designs, and/or otherwise advance the art of elastomeric articles.

### BRIEF SUMMARY

One example of an elastomeric article in accordance with the subject matter of the present disclosure can include an elastomeric body that is at least partially formed from an elastomeric material. The elastomeric body can include a first surface portion and a second surface portion facing opposite the first surface portion. A first plurality of reinforcing elements can be embedded within the elastomeric body between the first and second surface portions. The first plurality of reinforcing elements can have a first end and a second end opposite the first end with the first plurality of reinforcing elements having a non-linear pattern formed therealong between the first and second ends thereof.

In some cases, an elastomeric article according to the foregoing paragraph can at least partially form one of pneumatic or non-pneumatic tire, a flexible spring member of a gas spring assembly and/or a turnup bladder dimensioned for securement on an associated tire building machine.

One example of a tire in accordance with the subject matter of the present disclosure can include an elastomeric casing that is at least partially formed from an elastomeric material. The elastomeric casing can include an axis of rotation, a crown portion extending peripherally about the axis and lengthwise in a generally axial direction. The elastomeric casing can also include first and second sidewalls disposed in axially-spaced relation to one another and extending radially inwardly from along the crown portion to respective first and second bead areas. A first annular bead reinforcing element can be embedded within the first bead area and a second annular bead reinforcing element can be embedded within the second bead area. A plurality of reinforcing elements can be embedded within the elastomeric casing. The plurality of reinforcing elements can have a first end and a second end opposite the first end with the first plurality of reinforcing elements having a non-linear pattern formed therealong between the first and second ends thereof. The plurality of reinforcing elements can extend between and operatively engage the first and second annular bead reinforcing elements.

In some cases, a tire according to the foregoing paragraph can also include one or more belts extending peripherally along the crown portion radially outward of at least the plurality of reinforcing elements. Additionally, in some cases, a tread can, optionally, extend peripherally about the axis radially outward of the one or more belts.

One example of a gas spring assembly in accordance with the subject matter of the present disclosure can include a flexible spring member that is at least partially formed from an elastomeric material. The flexible spring member can have a longitudinal axis, and can extend peripherally about the longitudinal axis between a first end and a second end spaced longitudinally from the first end. The flexible spring member can include a flexible wall that includes a first surface portion that at least partially defines an exterior of the flexible spring member and a second surface portion that at least partially defines a spring chamber within the flexible spring member. The flexible spring member can include a first mounting bead formed along the first end and a first annular bead reinforcing element can be embedded within the first end. A plurality of reinforcing elements can be embedded within the flexible spring member between the first and second surface portions thereof. The plurality of reinforcing elements can have a first end and a second end opposite the first end with the first plurality of reinforcing elements having a non-linear pattern formed therealong between the first and second ends thereof. The plurality of reinforcing elements can be operatively secured to the first annular bead reinforcing element. A first end member can be secured across the first end of the flexible spring member such that a substantially fluid-tight connection is formed therebetween. A second end member can be secured across the second end of the flexible spring member such that a substantially fluid-tight connection is formed therebetween.

One example of a turnup bladder in accordance with the subject matter of the present disclosure can include a flexible spring member that is at least partially formed from an elastomeric material. The flexible spring member can have a longitudinal axis, and can extend peripherally about the longitudinal axis between a first end and a second end spaced longitudinally from the first end. The flexible spring member can include a flexible wall that includes a first surface portion that at least partially defines an exterior of the flexible spring member and a second surface portion that at least partially defines a bladder chamber within the flexible spring member. The flexible spring member can include a first mounting bead formed along the first end and a second mounting bead formed along the second end. A first annular bead reinforcing element can be embedded within the first mounting bead along the first end, and a second annular bead reinforcing element can be embedded within the second mounting bead along the second end. A plurality of reinforcing elements can be embedded within the flexible spring member between the first and second surface portions thereof. The plurality of reinforcing elements can have a first end and a second end opposite the first end with the first plurality of reinforcing elements having a non-linear pattern formed therealong between the first and second ends thereof. The plurality of reinforcing elements can be operatively secured to the first and second annular bead reinforcing elements. The first mounting bead can at least partially define a first opening and the second mounting bead can at least partially define a second opening. The first and second openings can be dimensioned for securement to an associated tire building machine.

One example of a method of manufacturing an elastomeric article in accordance with the subject matter of the present disclosure can include forming a first layer of elastomeric material with a first inner surface and a first surface portion of the elastomeric article. The method can also include positioning a first plurality of reinforcing elements having a non-linear pattern along the first inner surface of the first layer of elastomeric material. The method can further include applying a second layer of elastomeric material along the first inner surface and overtop of the first plurality of reinforcing elements such that the first plurality of reinforcing elements are encapsulated by the first and second layers of elastomeric material.

### BRIEF DESCRIPTION OF THE DRAWINGS

FIG. 1 is a schematic representation of one example of a vehicle including one or more elastomeric articles, such as tires and gas spring assemblies, in accordance with the subject matter of the present disclosure.

FIG. 2 is a side view of one example of a tire and wheel assembly that includes a pneumatic tire in accordance with the subject matter of the present disclosure.

FIG. 3 is a cross-sectional view of the assembly in FIG. 2 taken from along line 3-3 thereof.

FIG. 4 is a side view of one example of a gas spring assembly that includes an elastomeric article, such as a flexible spring member, in accordance with the subject matter of the present disclosure.

FIG. 5 is a cross-sectional side view of the gas spring assembly in FIG. 4 taken from along line 5-5 thereof.

FIG. 6 is a side view of another example of a gas spring assembly that includes an elastomeric article, such as a flexible spring member, in accordance with the subject matter of the present disclosure.

FIG. 7 is a top plan view of the gas spring assembly in FIG. 6.

FIG. 8 is a cross-sectional side view of the gas spring assembly in FIGS. 6 and 7 taken from along line 8-8 in FIG. 7.

FIG. 9 is a side view of one example of a tire building machine including an elastomeric article, such as a turnup bladder, in accordance with the subject matter of the present disclosure.

FIG. 10 is a cross-sectional side view of the exemplary turnup bladder shown in FIG. 9 shown prior to installation.

FIG. 11 a top plan view of one example of a flexible wall construction in accordance with the subject matter of the present disclosure.

FIG. 12 is a top plan view of an alternate version of the flexible wall construction in FIG. 11.

FIG. 13 is a cross-sectional side view of the flexible wall constructions in FIGS. 11 and 12.

FIG. 14 is an exploded view of layers of the flexible wall constructions in FIGS. 11-13 prior to assembly.

FIG. 15 a top plan view of another example of a flexible wall construction in accordance with the subject matter of the present disclosure.

FIG. 16 is a top plan view of an alternate version of the flexible wall construction in FIG. 15.

FIG. 17 is a cross-sectional side view of the flexible wall constructions in FIGS. 15 and 16.

FIG. 18 is an exploded view of layers of the flexible wall constructions in FIGS. 15-17 prior to assembly.

FIG. 19 is a cross-sectional side view of one example of a reinforcing element and core assembly in accordance with the subject matter of the present disclosure.

FIG. 20 is a cross-sectional side view of another example of a reinforcing element and core assembly in accordance with the subject matter of the present disclosure.

### DETAILED DESCRIPTION

As used herein, terms such as “fiber,” “filament,” and the like, are used interchangeably in reference to individual elements of material having a small cross-sectional dimension and an indefinite elongated length.

As used herein, terms such as “yarn”, “tow” and the like, are used in reference to a plurality of filaments that are laid, twisted and/or otherwise bundled together in a continuous, elongated strand of indefinite length. As one example, a yarn can include a quantity of filaments within a range of from approximately 10 filaments to approximately 500,000 filaments depending upon the type and kind of material from which the filaments are made.

As used herein, terms such as “cord” and the like, are used in reference to the product of one or more yarns that may be laid, twisted or otherwise bundled together in a continuous, elongated strand of indefinite length. In some cases, the one or more of the yarns in a cord may be treated with a binder, adhesive and/or matrix material.

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purposes of clarity and/or ease of understanding.

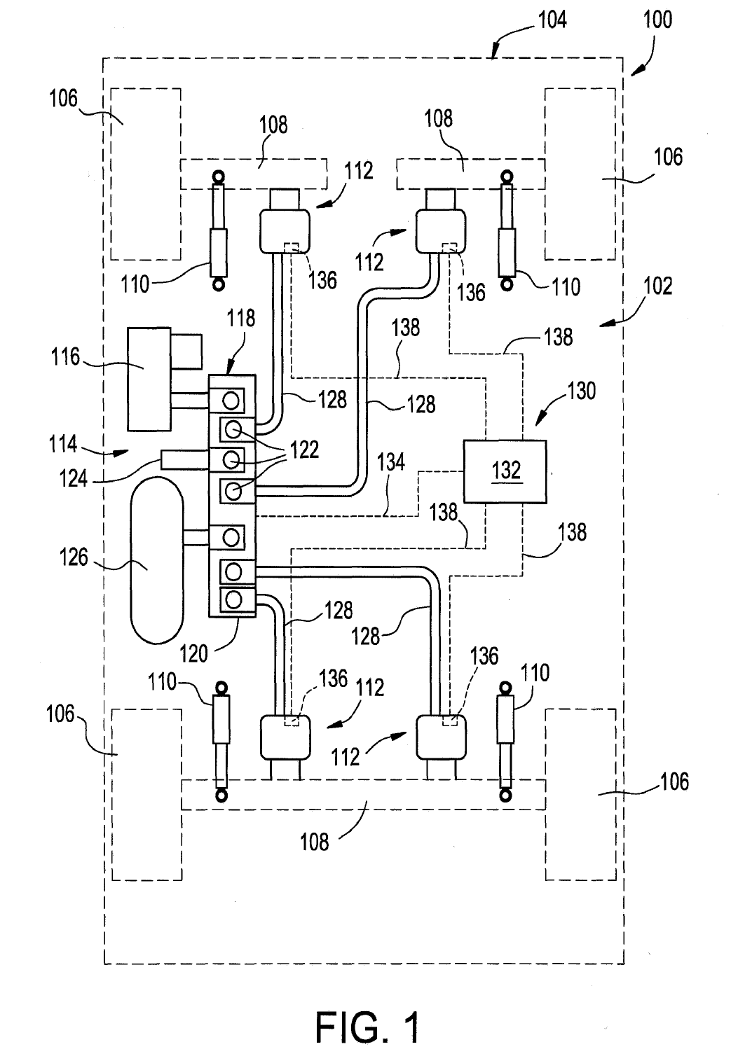

FIG. 1 illustrates one example of a vehicle 100 that can include one or more elastomeric articles in accordance with the subject matter of the present disclosure. Vehicle 100 is shown as including a suspension system 102 disposed between a sprung mass, such as a vehicle body 104, for example, and an unsprung mass, such as tire and wheel assemblies 106 and axles 108, for example. It will be appreciated that any one or more of the components of the suspension system can be operatively connected between the sprung and unsprung masses of vehicle 100 in any suitable manner. Additionally, it will also be appreciated that suspension system 102 can also optionally include a plurality of damping members, such as dampers 110, for example, and that any such damping members can also be operatively connected between the sprung and unsprung masses of the vehicle in any suitable manner.

Suspension system 102 can also include a plurality of gas spring assemblies supported between the sprung and unsprung masses of the associated vehicle. In the arrangement shown in FIG. 1, suspension system 102 includes four gas spring assemblies 112, one of which is disposed toward each corner of the vehicle adjacent a corresponding wheel assembly 106. However, it will be appreciated that any other suitable number of gas spring assemblies could alternately be used in any other configuration or arrangement. As shown in FIG. 1, gas spring assemblies 112 are supported between axles 108 and body 104 of vehicle 100. Additionally, it will be recognized that the gas spring assemblies shown and described in FIG. 1 (e.g., gas spring assemblies 112) are illustrated as being of a rolling lobe-type construction. It is to be understood, however, that gas spring assemblies of other types, kinds and/or constructions (e.g., convoluted bellows-type) could alternately be used.

Suspension system 102 also includes a pressurized gas system 114 operatively associated with the gas spring assemblies for selectively supplying pressurized gas (e.g., air) thereto and selectively transferring pressurized gas therefrom. In the exemplary embodiment shown in FIG. 1, pressurized gas system 114 includes a pressurized gas source, such as a compressor 116, for example, for generating pressurized air or other gases. A control device, such as a valve assembly 118, for example, is shown as being in communication with compressor 116 and can be of any suitable configuration or arrangement. In the exemplary embodiment shown, valve assembly 118 includes a valve block 120 with a plurality of valves 122 supported thereon. Valve assembly 118 can also optionally include a suitable exhaust, such as a muffler 124, for example, for venting pressurized gas from the system. Optionally, pressurized gas system 114 can also include a reservoir 126 in fluid communication with the compressor and/or valve assembly 118 and suitable for storing pressurized gas for an extended period of time.

Valve assembly 118 is in communication with gas spring assemblies 112 through suitable gas transfer lines 128. As such, pressurized gas can be selectively transferred into and/or out of the gas spring assemblies through valve assembly 118 by selectively operating valves 122, such as to alter or maintain vehicle height at one or more corners of the vehicle, for example.

Suspension system 102 can also include a control system 130 that is capable of communication with any one or more systems and/or components (not shown) of vehicle 100 and/or suspension system 102, such as for selective operation and/or control thereof. Control system 130 can include a controller or electronic control unit (ECU) 132 communicatively coupled with compressor 116 and/or valve assembly 118, such as through a conductor or lead 134, for example, for selective operation and control thereof, which can include supplying and exhausting pressurized gas to and/or from gas spring assemblies 112. Controller 132 can be of any suitable type, kind and/or configuration.

Control system 130 can also, optionally, include one or more height (or distance) sensing devices 136, such as, for example, may be operatively associated with the gas spring assemblies and capable of outputting or otherwise generating data, signals and/or other communications having a relation to a height of the gas spring assemblies or a distance between other components of the vehicle. Such height sensing devices can be in communication with ECU 132, which can receive the height or distance signals therefrom. The height sensing devices can be in communication with ECU 132 in any suitable manner, such as through conductors or leads 138, for example. Additionally, it will be appreciated that the height sensing devices can be of any suitable type, kind and/or construction.

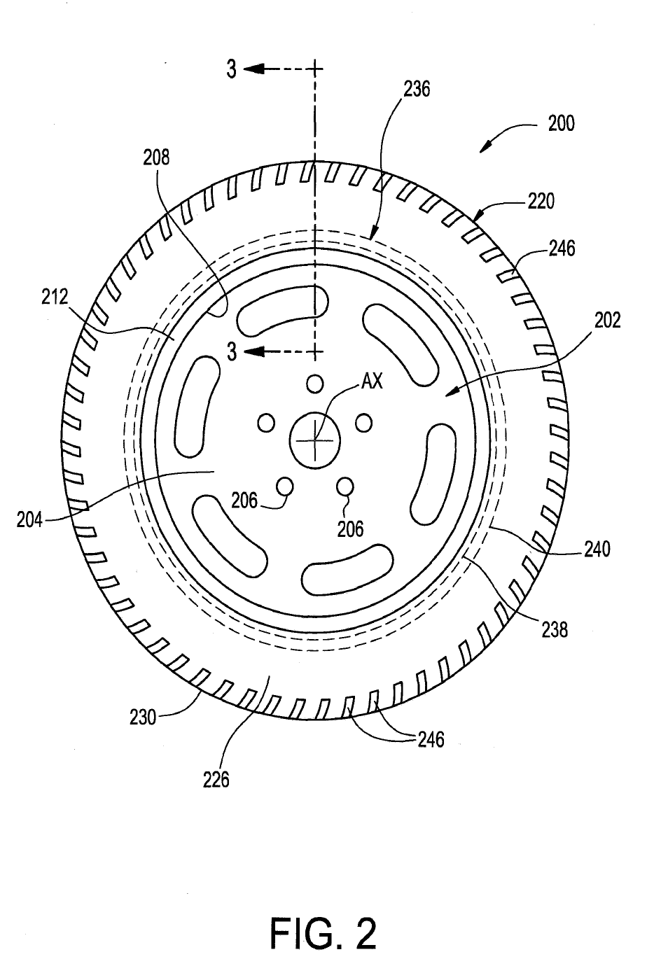

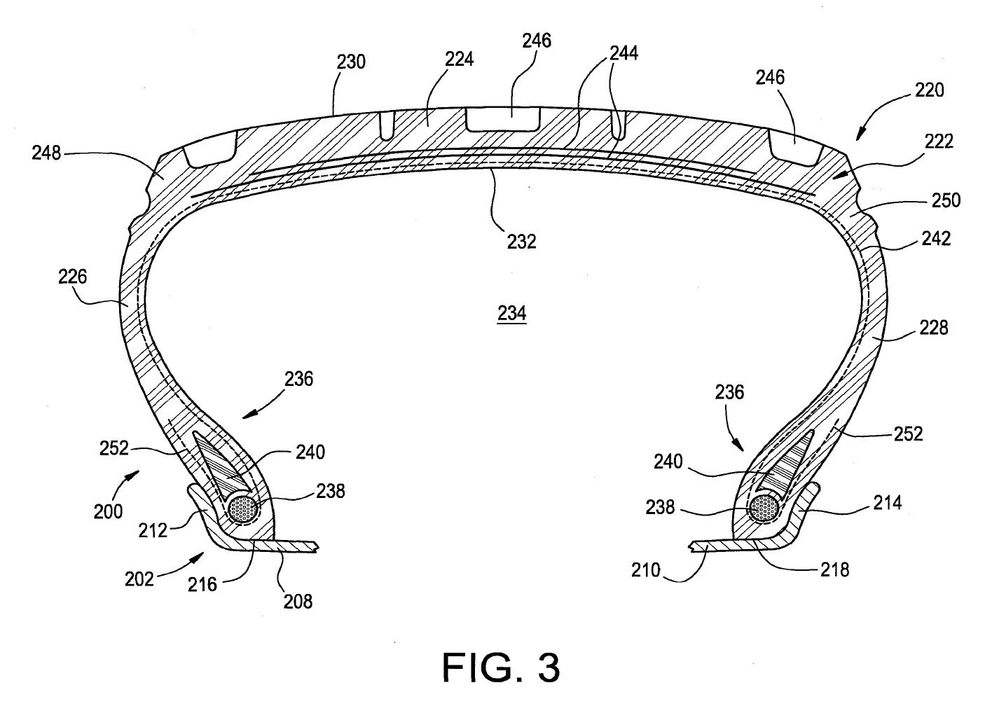

One example of a tire and wheel assembly 200 in accordance with the subject matter of the present disclosure, such as may be suitable for use as one of tire and wheel assemblies 106 in FIG. 1, for example, is shown in FIGS. 2 and 3 as including a conventional wheel 202 that permits operation and use of an elastomeric article in the form of a pneumatic tire in an inflated condition. In the exemplary arrangement in FIGS. 2 and 3, wheel 202, which can be of any suitable type, kind, construction and/or configuration, is shown as including a mounting hub 204 having a plurality of mounting holes 206 in a suitable hole pattern. Wheel 202 is also shown as including opposing rim walls 208 and 210 that terminate at corresponding flanges 212 and 214. As illustrated in FIG. 3, bead seats 216 and 218 are respectively formed along rim walls 208 and 210 adjacent flanges 212 and 214.

Assembly 200 also includes an elastomeric article in the form of a pneumatic tire 220 that extends circumferentially about an axis AX (FIG. 2) and includes an elastomeric casing 222 that has a crown portion 224 and axially-spaced sidewalls 226 and 228 that extend radially inward from along crown portion 224. The crown portion includes an outer surface 230 and an inner surface 232 that at least partially defines a tire cavity 234.

In the exemplary arrangement shown in FIGS. 2 and 3, pneumatic tire 220 includes bead areas 236 (which, in some cases, may be alternately referred to as “mounting beads” or “mounting bead areas”) that form the radially-inward extent of sidewalls 226 and 228. The bead areas are dimensioned or otherwise adapted to form an air-tight relationship along bead seats 216 and 218 in an installed condition of pneumatic tire 220 on wheel 202. As such, when mounted on a wheel, pneumatic tire 220 can be inflated through a conventional valve (not shown) that is operatively connected with tire cavity 234, such as through one of rim walls 208 and 210 of wheel 202, for example. Additionally, it will be appreciated that bead areas having a wide variety of combinations of shapes, sizes, features and elements have been developed and can be included on pneumatic tire 220. Non-limiting examples of such features and elements include bead toe features, bead heel features, bead flippers, bead chippers, and chaffing strips.

Regardless of the one or more other features and/or elements that may be included on or along the bead areas of a pneumatic tire in accordance with the subject matter of the present disclosure, the bead areas of pneumatic tire 220 can also include at least one bead reinforcing element. In the exemplary arrangement in FIGS. 2 and 3, for example, bead areas 236 of pneumatic tire 220 are each shown as including bead reinforcing elements in the forms of a bead core 238 and a bead filler 240.

As is well known in the art, pneumatic tires, such as pneumatic tire 220, for example, also include one or more plies containing a multiplicity of closely-spaced reinforcing cords or wires that extend across the crown portion of the tire casing and radially inward along the sidewalls of the tire casing. In the exemplary arrangement in FIGS. 2 and 3, tire casing 222 (FIG. 3) shown as being reinforced by a reinforcing layer or ply 242 that extends across crown portion 224 and along sidewalls 226 and 228 toward bead areas 236. In accordance with the subject matter of the present disclosure, reinforcing ply 242 can be formed from a plurality of reinforcing elements that extend radially across tire casing 222 in a non-linear pattern, such as is described hereinafter in greater detail. Further reinforcement of the tire can be provided by one or more annular belts, such as belts 244 that extend circumferentially along crown portion 224, for example. Reinforcing ply 242 and belts 244 can be fabricated of any suitable material or combination of materials, such as steel wires, polymeric cords and/or suitable textile cords, for example, as is well known in the art.

Tire 220 can also include a tread 246 that extends circumferentially about tire casing 222 and extends axially between opposing first and second shoulders 248 and 250, which shoulders generally transition tread 246 into sidewalls 226 and 228, respectively. Tread 246 can include any suitable combination of grooves, tread elements or lugs and tread void areas in any suitable size, shape and/or pattern, as is well known in the art.

Bead cores 238 can take the form of substantially-inextensible, endless rings that are embedded within bead areas 236. One function of bead reinforcing elements (e.g., bead cores 238) is to establish and maintain the cross-sectional dimension of bead areas 236 and the openings formed thereby such that the pneumatic tire can be mounted along corresponding bead seats of an associated wheel (e.g., bead seats 216 and 218 of wheel 202), such as may be established by industry standards and conventions.

Another function of bead reinforcing elements (e.g., bead cores 238) is to anchor reinforcing layers or plies, such as reinforcing ply 242, for example, as the same extend across the tire carcass between the opposing bead areas. It will be appreciated that the reinforcing elements of such one or more reinforcing plies can be anchored by bead cores 238 in any suitable manner. For example, reinforcing ply 242 is shown in FIG. 2 as extending from along sidewalls 226 and 228 toward bead areas 236.

Reinforcing ply 242 extends in a radially-inward direction along an axially-inward side of bead cores 238 and through the opening formed by the bead core. Outer ends 252 of reinforcing ply 242 are turned up along an axially-outward side of bead cores 238 and return in a radially-outward direction along sidewalls 226 and 228. Bead fillers 240 are shown disposed adjacent bead cores 238 in an area between reinforcing ply 242 and outer ends 252, and can operate to at least partially fill any gap between reinforcing ply 242 and outer end 252 and/or can operate to provide added rigidity and/or stiffness to the bead area. It will be appreciated, however, that other arrangements and/or configurations could alternately be used, and that the arrangement shown is merely exemplary.

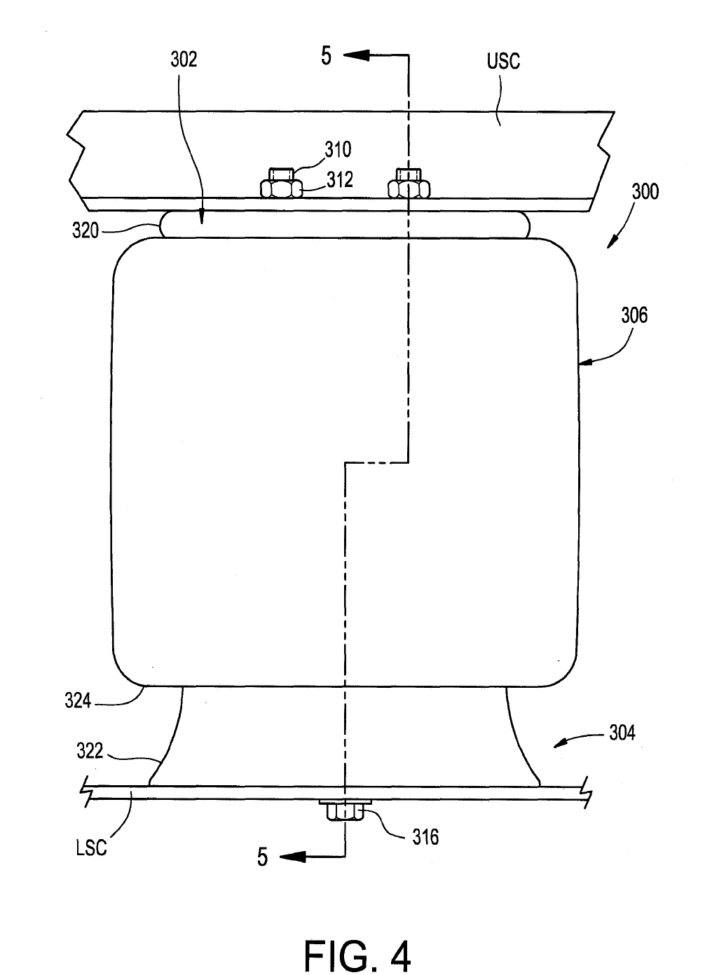

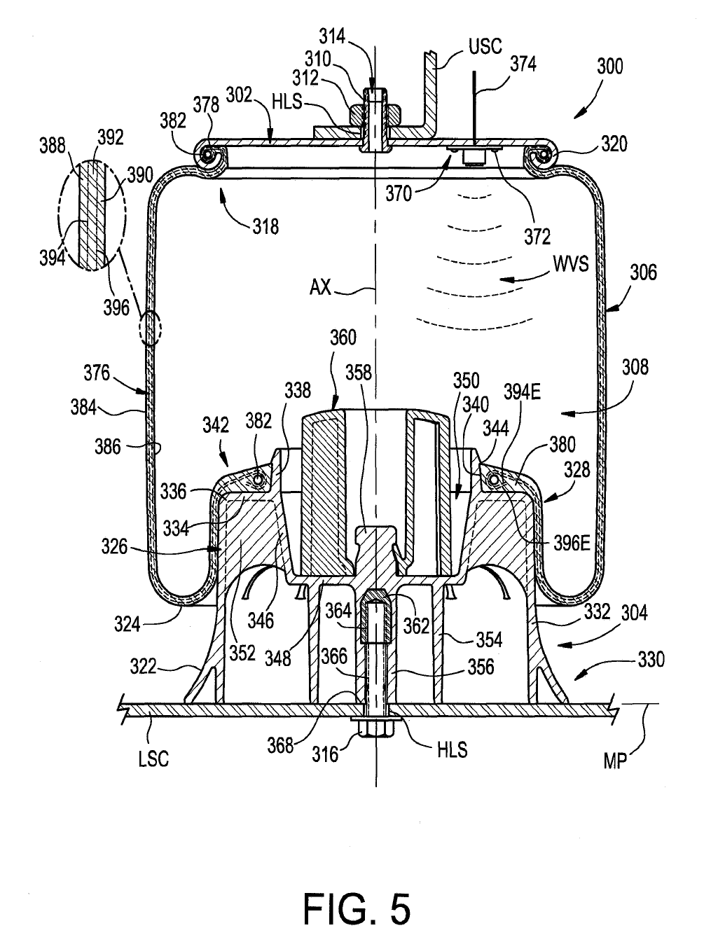

One example of a gas spring assembly 300 in accordance with the subject matter of the present disclosure, such as may be suitable for use as one of gas spring assemblies 112 in FIG. 1, for example, is shown in FIGS. 4 and 5 as having a longitudinally-extending axis AX (FIG. 5). Gas spring assembly 300 can include one or more end members, such as an end member 302 and an end member 304 that is spaced longitudinally from end member 302. A flexible spring member 306 can extend peripherally around axis AX and can be secured between the end members in a substantially fluid-tight manner such that a spring chamber 308 (FIG. 5) is at least partially defined therebetween.

Gas spring assembly 300 can be disposed between associated sprung and unsprung masses of an associated vehicle in any suitable manner. For example, one end member can be operatively connected to the associated sprung mass with the other end member disposed toward and operatively connected to the associated unsprung mass. In the embodiment shown in FIGS. 4 and 5, for example, end member 302 is secured along a first or upper structural component USC, such as vehicle body 104 in FIG. 1, for example, and can be secured thereon in any suitable manner. For example, one or more securement devices, such as mounting studs 310, for example, can be included along end member 302. In some cases, the one or more securement devices (e.g., mounting studs 310) can project outwardly from end member 302 and can be secured thereon in a suitable manner, such as, for example, by way of a flowed-material joint (not shown) or a press-fit connection (not identified). Additionally, such one or more securement devices can extend through mounting holes HLS in upper structural component USC and receive one or more threaded nuts 312 or other securement devices, for example. As an alternative to one or more of mounting studs 310, one or more threaded passages (e.g., blind passages and/or through passages) could be used in conjunction with a corresponding number of one or more threaded fasteners.

Additionally, a fluid communication port, such as a transfer passage 314 (FIG. 5), for example, can optionally be provided to permit fluid communication with spring chamber 308, such as may be used for transferring pressurized gas into and/or out of the spring chamber, for example. In the exemplary embodiment shown, transfer passage 314 extends through at least one of mounting studs 310 and is in fluid communication with spring chamber 308. It will be appreciated, however, that any other suitable fluid communication arrangement could alternately be used.

End member 304 can be secured along a second or lower structural component LSC, such as an axle 108 in FIG. 1, for example, in any suitable manner. As one example, lower structural component LSC could include one or more mounting holes HLS extending therethrough. In such case, a threaded fastener 316 could extend through one of mounting holes HLS and threadably engage end member 304 to secure the end member on or along the lower structural component.

It will be appreciated that the one or more end members can be of any suitable type, kind, construction and/or configuration, and can be operatively connected or otherwise secured to the flexible wall in any suitable manner. In the exemplary arrangement shown in FIGS. 4 and 5, for example, end member 302 is of a type commonly referred to as a bead plate and is secured to a first end 318 of flexible spring member 306 using a crimped-edge connection 320. End member 304 is shown in the exemplary arrangement in FIGS. 4 and 5 as being of a type commonly referred to as a piston (or a roll-off piston) that has an outer surface 322 that abuttingly engages flexible spring member 306 such that a rolling lobe 324 is formed therealong. As gas spring assembly 300 is displaced between extended and collapsed conditions during use, rolling lobe 324 is displaced along outer surface 322 in a conventional manner.

As identified in FIG. 5, end member 304 includes an end member body 326 and extends from along a first or upper end 328 toward a second or lower end 330 that is spaced longitudinally from end 328. Body 326 includes a longitudinally-extending outer side wall 332 that extends peripherally about axis AX and at least partially defines outer surface 322. An end wall 334 is disposed transverse to axis AX and extends radially inward from along a shoulder portion 336, which is disposed along the outer side wall toward end 328. Body 326 also includes a first inner side wall 338 that extends longitudinally outward beyond end wall 334 and peripherally about axis AX. First inner side wall 338 has an outer surface 340 that is dimensioned to receive a second end 342 of flexible spring member 306 such that a substantially fluid-tight seal can be formed therebetween. A retaining ridge 344 can project radially outward from along first inner side wall 338 and can extend peripherally along at least a portion thereof to aid in retaining second end 342 on or along outer surface 340 of first inner side wall 338.

Body 326 also includes a second inner side wall 346 that extends longitudinally inward into the body from along end wall 334. Second inner side wall 346 terminates at an end or bottom wall 348 that is approximately planar and disposed transverse to axis AX such that second inner side wall 346 and bottom wall 348 at least partially define a cavity 350 within body 326. In some cases, bridge walls 352 can, optionally, extend between and operatively interconnect outer side wall 332 and second inner side wall 346.

An inner support wall 354 is disposed radially inward from outer side wall 332 and extends peripherally about axis AX. In some cases, inner support wall 354 can form a hollow column-like structure that projects from along bottom wall 348 in a longitudinal direction toward end 330. In some cases, the distal end of outer side wall 332 and/or the distal end of inner support wall 354 can at least partially define a mounting plane MP formed along end 330 of the end member body. In this manner, body 326 can be supported at least in part by outer side wall 332 and/or inner support wall 354, such as on or along an associated structural member (e.g., lower structural component LSC in FIGS. 4 and 5). In some cases, axially applied loads or forces transmitted to bottom wall 348, such as from impacts imparted on a jounce bumper, for example, can be reacted, communicated or otherwise at least partially transferred to the associated structural component by the inner support wall.

Body 326 can also include a central or support post wall 356 that is disposed radially inward from inner support wall 354 and forms a post-like structure that projects from along bottom wall 348 in a direction toward end 330. In some cases, central wall 356 can terminate in approximate alignment with mounting plane MP, such as is illustrated in FIG. 5, for example.

In the exemplary arrangement shown in FIGS. 4 and 5, body 326 of end member 304 can also include a bumper mount 358 that is disposed along bottom wall 348 and projects outwardly therefrom in an axial direction toward end 328 of the end member body. Gas spring assembly 300 can also, optionally, include a jounce bumper 360 that can be supported within spring chamber 308, such as to inhibit direct contact between end members 302 and 304, for example. It will be appreciated that the jounce bumper, if included, can be supported on or along an end member in any suitable manner. For example, jounce bumper 394 is shown as being received on and retained by bumper mount 358.

End member 304 can include an insert or other securement device 362 that is embedded (e.g., molded) into or otherwise captured and retained within end member body 326. Securement device 362 can function to assist in securing the end member on or along an associated structural component, such as providing a mounting and/or securement point for the end member. It will be appreciated that any suitable configuration and/or combination of features and characteristics can be included on or along the insert to perform such function. As one example, securement device 362 can include a hole or opening 364 extending into the securement device with one or more helical threads formed therealong that are cooperative with one or more helical threads formed on or along threaded fastener 316, for example. Securement device 362 can be accessible through a passage 366 that extends into central wall 356 of end member 304 from along an end surface 368.

In some cases, gas spring assembly 300 can, optionally, include a height or distance sensing device 370 disposed within spring chamber 308. If provided, height sensing device 370 can be secured on or along end member 302, such as by way of suitable fasteners 372. Height sensing device 370 can be of any suitable type, kind and/or construction, such as an ultrasonic sensor that transmits and receives ultrasonic waves WVS (FIG. 5), for example. Additionally, it will be appreciated that height sensing device 370 can be connected to other systems and/or components of a vehicle suspension system in any suitable manner. As shown in FIGS. 4 and 5, height sensing device 370 can include a lead or connection 374 that can be used for such communication purposes, such as is indicated by leads 138 of control system 130 in FIG. 1, for example.

As discussed above, gas spring assembly 300 can include an elastomeric article in accordance with the subject matter of the present disclosure in the form of flexible spring member 306. It will be appreciated that flexible spring member 306 can be of any suitable size, shape, construction and/or configuration in accordance with the present disclosure. For example, flexible spring member 306 is shown in FIGS. 4 and 5 as including a flexible wall 376 that is formed from a quantity of elastomeric material and includes one or more reinforcing plies formed from a plurality of reinforcing elements that extend through the elastomeric material in a non-linear pattern, such as is described hereinafter in greater detail.

Flexible wall 376 can be constructed in any suitable manner and from any suitable material or combination of materials, such as by using one or more reinforcing plies or layers and zero or more un-reinforced, elastomeric plies or layers, for example. Typically, one or more reinforcing plies and one or more un-reinforced, elastomeric plies will be used together and formed from a common elastomeric material, such as a synthetic rubber, a natural rubber or a thermoplastic elastomer. In other cases, however, a combination of two or more different materials, two or more compounds of similar materials, or two or more grades of the same material could be used.

As discussed above, flexible spring member 306 can include any feature or combination of features suitable for forming a substantially fluid-tight connection with end member 302 and/or end member 304. As one example, flexible spring member 306 can include a mounting bead 378 disposed along end 318 and a mounting bead 380 disposed along end 342. In such cases, the mounting beads, if provided, can, optionally, include a reinforcing element, such as an endless, annular bead wire 382, for example.

Flexible wall 376 can extend in a generally longitudinal direction between opposing first and second ends 318 and 342 of flexible spring member 306.

Additionally, flexible wall 376 can include an outer surface 384 and an inner surface 386, which can at least partially define a spring chamber 308. Flexible wall 376 can include an outer or cover ply 388 that at least partially forms outer surface 384, and inner or liner ply 390 that at least partially forms inner surface 386. In some cases, flexible wall 376 can, optionally, include an intermediate or spacer ply 392 disposed between the outer and inner plies.

In accordance with the subject matter of the present disclosure, flexible wall 376 further includes one or more reinforcing plies disposed between outer and inner surfaces 384 and 386. The one or more reinforcing plies can include a plurality of reinforcing elements that are embedded within the flexible wall in a non-linear pattern, such as is described hereinafter in greater detail. In some cases, two or more reinforcing plies can be used. In the arrangement shown in FIG. 5, for example, reinforcing plies 394 and 396, in accordance with the subject matter of the present disclosure, are shown as extending along flexible wall 376 and being substantially entirely embedded within the elastomeric material thereof, such as between adjacent ones of cover ply 388, spacer ply 392 and liner ply 390, for example. In some cases, one or more of the reinforcing plies and the plurality of the reinforcing elements thereof can be anchored or secured within the mounting bead. For example, ply ends 394E and 396E are shown in FIG. 5 as extending through and at least partially wrapping around bead wires 382 along both of ends 318 and 342. It will be appreciated that other configurations and/or arrangements could alternately be used.

It will be appreciated that the reinforcing elements of the reinforcing plies will extend in a lengthwise direction, and that the one or more reinforcing plies can be oriented in any suitable manner relative to longitudinal axis AX, relative to one another and/or relative to other features of gas spring assembly 300. As one example, the flexible wall can include at least one reinforcing layer or ply with reinforcing elements oriented in an approximately axial direction. As another example, the flexible wall can include at least one reinforcing layer or ply with reinforcing elements oriented lengthwise at one bias angle relative to axis AX, and at least one reinforcing layer or ply with reinforcing elements oriented lengthwise at another bias angle. In some cases, the two bias angles can be approximately equal but oriented opposite one another relative to axis AX.

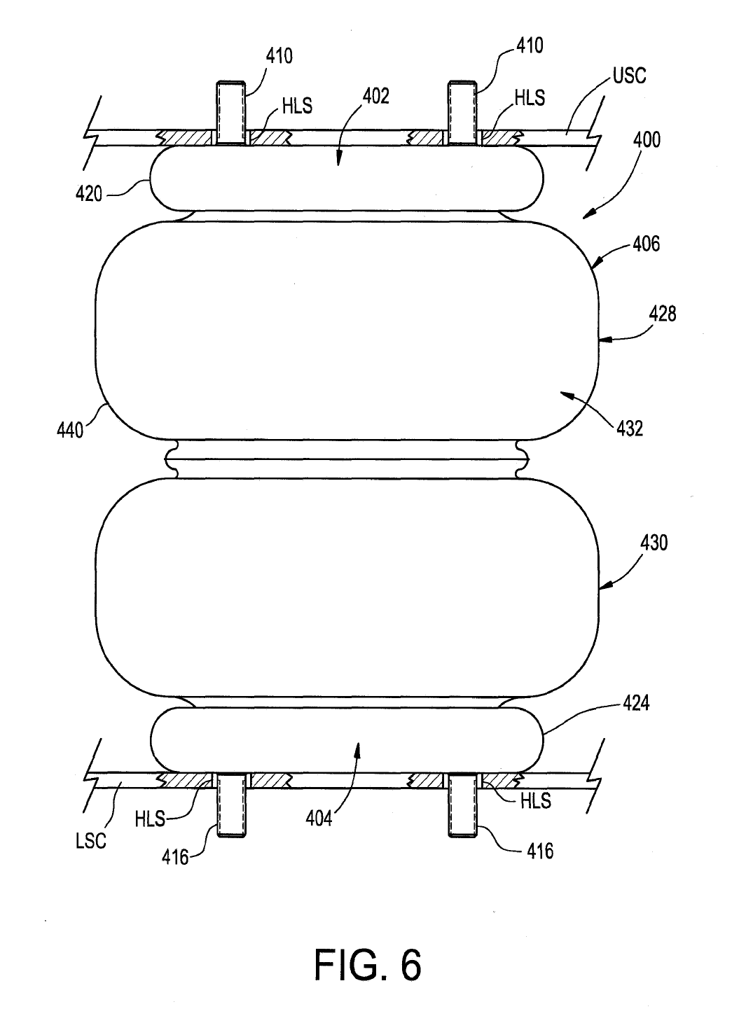

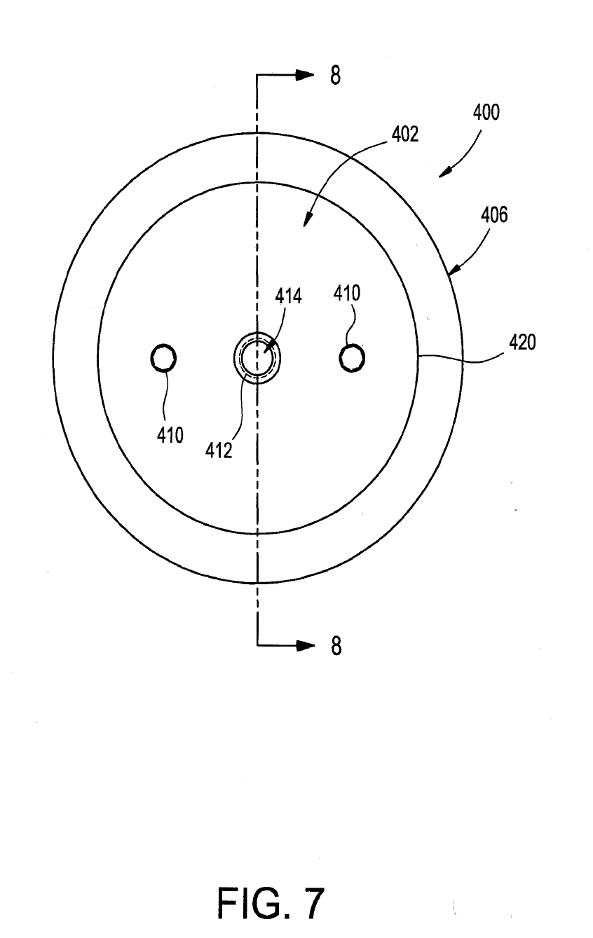

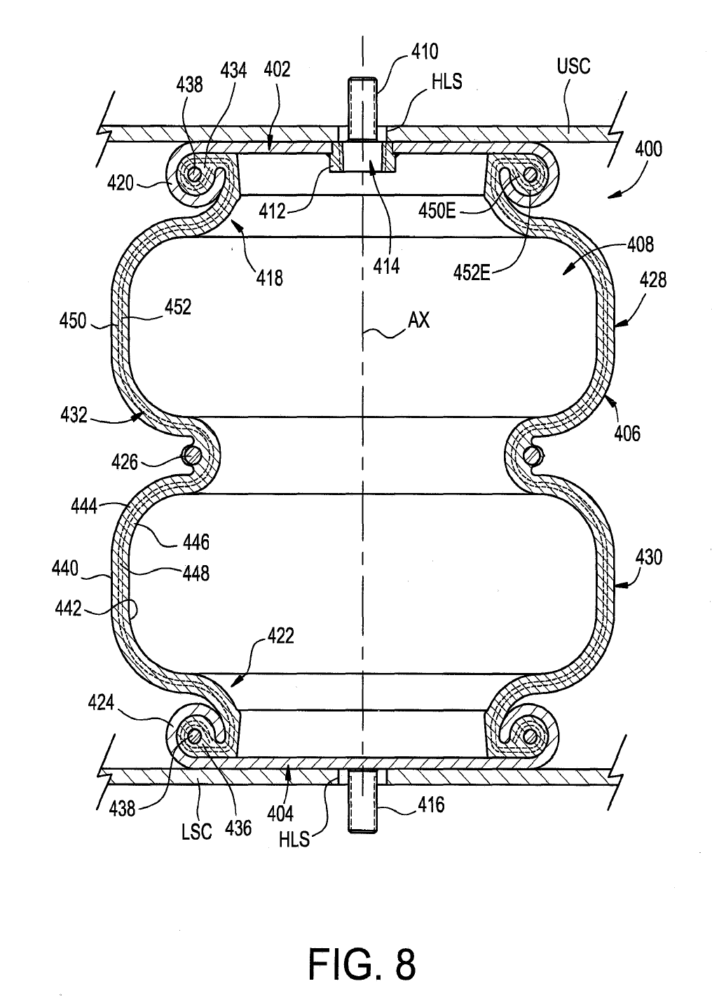

Another example of a gas spring assembly 400 in accordance with the subject matter of the present disclosure, such as may be suitable for use as one of gas spring assemblies 112 in FIG. 1, for example, is shown in FIGS. 6-8 as having a longitudinally-extending axis AX (FIG. 8). Gas spring assembly 400 can include one or more end members, such as an end member 402 and an end member 404 that is spaced longitudinally from end member 402. A flexible spring member 406 can extend peripherally around axis AX and can be secured between the end members in a substantially fluid-tight manner such that a spring chamber 408 (FIG. 8) is at least partially defined therebetween.

Gas spring assembly 400 can be disposed between associated sprung and unsprung masses of an associated vehicle in any suitable manner. For example, one end member can be operatively connected to the associated sprung mass with the other end member disposed toward and operatively connected to the associated unsprung mass. In the arrangement shown in FIGS. 6-8, for example, end member 402 is secured along a first or upper structural component USC, such as vehicle body 104 in FIG. 1, for example, and can be secured thereon in any suitable manner. For example, one or more securement devices, such as mounting studs 410, for example, can be included along end member 402. In some cases, the one or more securement devices (e.g., mounting studs 410) can project outwardly from end member 402 and can be secured thereon in a suitable manner, such as, for example, by way of a flowed-material joint (not shown) or a press-fit connection (not identified). Additionally, such one or more securement devices can extend through mounting holes HLS in upper structural component USC and receive one or more threaded nuts or other securement devices, for example.

Additionally, one or more gas transfer ports can optionally be provided to permit fluid communication with spring chamber 408, such as may be used for transferring pressurized gas into and/or out of the spring chamber. For example, a connection can be provided on or along one of the end members (e.g., end member 402) such as may be used for attachment of a gas transfer line (e.g., one of gas transfer lines 128 in FIG. 1). In the exemplary arrangement shown in FIGS. 6-8, a connector fitting 412 is provided on or along one of the end members (e.g., end member 402) such as may be used for attachment of one of gas transfer lines 128 in FIG. 1, for example, and can include a passage 414 extending through the end member in fluid communication with spring chamber 408.

End member 404 can be secured along a second or lower structural component LSC, such as an axle 108 in FIG. 1, for example, in any suitable manner. As one example, lower structural component LSC could include one or more mounting holes HLS extending therethrough. One or more securement devices, such as mounting studs 416, for example, can be included along end member 404. In some cases, the one or more securement devices (e.g., mounting studs 416) can project outwardly from end member 404 and can be secured thereon in a suitable manner, such as, for example, by way of a flowed-material joint (not shown) or a press-fit connection (not identified). Additionally, such one or more securement devices can extend through mounting holes HLS in lower structural component USC and can receive one or more threaded nuts or other securement devices, for example. As an alternative to one or more of mounting studs 410 and/or 416, one or more threaded passages (e.g., blind passages and/or through passages) could be used in conjunction with a corresponding number of one or more threaded fasteners.

It will be appreciated that the one or more end members can be of any suitable type, kind, construction and/or configuration, and can be operatively connected or otherwise secured to the flexible spring member in any suitable manner. In the exemplary arrangement shown in FIGS. 6-8, for example, end members 402 and 404 are of a type commonly referred to as a bead plate. End member 402 is shown as being secured to a first end 418 of flexible spring member 406 using a crimped-edge connection in which an outer peripheral edge 420 of end member 402 is crimped or otherwise deformed about a portion of first end 418 of flexible spring member 406 such that a substantially fluid-tight seal is formed therebetween. Similarly, end member 404 is shown as being secured to a second end 422 of flexible spring member 406 using a crimped-edge connection in which an outer peripheral edge 424 of end member 404 is crimped or otherwise deformed about a portion of second end 422 of flexible spring member 406 such that a substantially fluid-tight seal is formed therebetween.

Gas spring assembly 400 is shown as being of a type commonly referred to as a convoluted or bellows-type construction, and it will be appreciated that any suitable type or kind of convoluted spring construction can be used. As such, the flexible spring member of the gas spring assembly can have any suitable number of one or more convoluted wall portions disposed between the opposing end members. In the exemplary arrangement shown in FIGS. 6-8, flexible spring member 406 includes a girdle hoop 426 (FIG. 8) disposed approximately midway along the flexible spring member. A convoluted wall portion 428 extends between the girdle hoop and end member 402, and a convoluted wall portion 430 extends between the girdle hoop and end member 404.

As discussed above, gas spring assembly 400 includes an elastomeric article in accordance with the subject matter of the present disclosure in the form of flexible spring member 406. It will be appreciated that flexible spring member 406 can be of any suitable size, shape, construction and/or configuration in accordance with the present disclosure. For example, flexible spring member 406 is shown in FIGS. 6-8 as including a flexible wall 432 that is formed from a quantity of elastomeric material and includes one or more reinforcing plies formed from a plurality of reinforcing elements that extend through the elastomeric material in a non-linear pattern, such as is described hereinafter in greater detail.

Flexible wall 432 can be constructed in any suitable manner and from any suitable material or combination of materials, such as by using one or more reinforcing plies or layers and zero or more un-reinforced, elastomeric plies or layers, for example. Typically, one or more reinforcing plies and one or more un-reinforced, elastomeric plies will be used together and formed from a common elastomeric material, such as a synthetic rubber, a natural rubber or a thermoplastic elastomer. In other cases, however, a combination of two or more different materials, two or more compounds of similar materials, or two or more grades of the same material could be used.

As discussed above, flexible spring member 406 can include any feature or combination of features suitable for forming a substantially fluid-tight connection with end member 402 and/or end member 404. As one example, flexible spring member 406 can include a mounting bead 434 disposed along end 418 and a mounting bead 436 disposed along end 422. In such cases, the mounting beads, if provided, can, optionally, include a reinforcing element, such as an endless, annular bead wire 438, for example.

Flexible wall 432 can extend in a generally longitudinal direction between opposing first and second ends 418 and 422 of flexible spring member 406.

Additionally, flexible wall 432 can include an outer surface 440 and an inner surface 442, which can at least partially define a spring chamber 408. Flexible wall 432 can include an outer or cover ply 444 that at least partially forms outer surface 440, and inner or liner ply 446 that at least partially forms inner surface 442. In some cases, flexible wall 432 can, optionally, include an intermediate or spacer ply 448 disposed between the outer and inner plies.

In accordance with the subject matter of the present disclosure, flexible wall 432 further includes one or more reinforcing plies disposed between outer and inner surfaces 440 and 442. The one or more reinforcing plies can include a plurality of reinforcing elements that are embedded within the flexible wall in a non-linear pattern, such as is described hereinafter in greater detail. In some cases, two or more reinforcing plies can be used. In the arrangement shown in FIG. 8, for example, reinforcing plies 450 and 452, in accordance with the subject matter of the present disclosure, are shown as extending along flexible wall 432 and being substantially entirely embedded within the elastomeric material thereof, such as between adjacent ones of cover ply 444, spacer ply 448 and liner ply 446, for example. In some cases, one or more of the reinforcing plies and the plurality of the reinforcing elements thereof can be anchored or secured within the mounting bead. For example, ply ends 450E and 452E are shown in FIG. 8 as extending through and at least partially wrapping around bead wires 438 along both of ends 418 and 422. It will be appreciated that other configurations and/or arrangements could alternately be used.

It will be appreciated that the reinforcing elements of the reinforcing plies will extend in a lengthwise direction, and that the one or more reinforcing plies can be oriented in any suitable manner relative to longitudinal axis AX, relative to one another and/or relative to other features of gas spring assembly 400. As one example, the flexible wall can include at least one reinforcing layer or ply with reinforcing elements oriented in an approximately axial direction. As another example, the flexible wall can include at least one reinforcing layer or ply with reinforcing elements oriented lengthwise at one bias angle relative to axis AX, and at least one reinforcing layer or ply with reinforcing elements oriented lengthwise at another bias angle. In some cases, the two bias angles can be approximately equal but oriented opposite one another relative to axis AX.

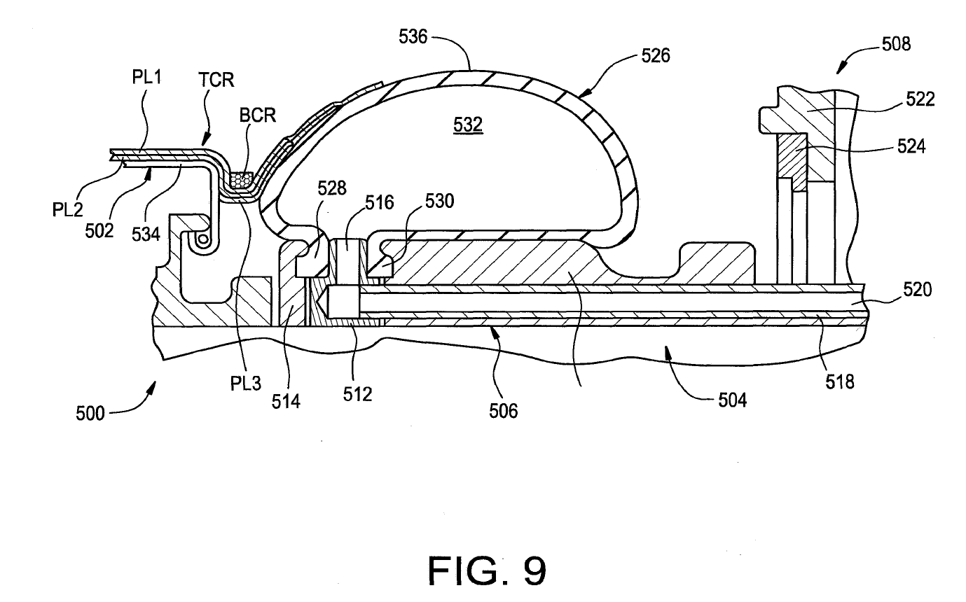

One example of a tire building machine 500 that includes an elastomeric article in accordance with the subject matter of the present disclosure in the form of a turnup bladder is shown in FIG. 9. Tire building machine 500 is shown performing a turnup operation in connection with the manufacture of an associated pneumatic tire. Tire building machine 500 can be of a generally conventional construction, and can include a tire building drum 502 and one or more support assemblies 504 disposed outwardly from the tire building drum. While only one support assembly is shown in FIG. 9, it will be appreciated that, in some cases, two support assemblies can be included, such as, for example, may be disposed on or along opposing sides of the tire building drum.

Support assembly 504 can include a base structure 506 and a reciprocal support assembly 508 that is laterally displaceable relative to at least base structure 506. Base structure 506 can include one or more annular support elements 510 as well as a gas transfer element 512 that is disposed between the one or more annular support elements and a retaining element 514. Gas transfer element 512 is shown as including one or more gas transfer ports 516 that can be in fluid communication with an associated pressurized gas system (not shown) in any suitable manner, such as by way of a gas transfer line 518 having a gas transfer passage 520 in fluid communication with gas transfer ports 516, for example. Additionally, reciprocal support assembly 508 can include a reciprocal support ring or element 522 and a bead-engaging element 524 that is disposed along the reciprocal support element.

Tire building machine 500 differs from conventional tire building machines in that tire building machine 500 includes an elastomeric article, in the form of a turnup bladder 526 in accordance with the subject matter of the present disclosure. Turnup bladder 526 is shown in FIG. 9 as being secured along support assembly 504 adjacent tire building drum 502. It will be appreciated that the turnup bladder can be secured on or along the support assembly in any suitable manner. As one example, turnup bladder 526 can include mounting beads 528 and 530 that are captured along base structure 506 such that a substantially fluid-tight seal is formed with mounting beads 528 and 530. In the arrangement shown in FIG. 9, mounting bead 528 is captured between gas transfer element 512 and retaining element 514, and mounting bead 530 is captured between gas transfer element 512 and annular support element 510. It will be appreciated, however, that other arrangements could alternately be used.

Turnup bladder 526 includes a bladder chamber 532 that is formed between mounting beads 528 and 530. In an installed condition on or along the tire building machine, bladder chamber 532 is in fluid communication with gas transfer port 516 such that pressurized gas can be selectively transferred into and out of bladder chamber 532 in connection with the use and/or operation of tire building machine 500. As mentioned above, an associated pressurized gas system (not shown) can selectively transfer pressurized gas into and out of the bladder chamber in a conventional manner.

In use, turnup bladder 526 is initially in a substantially deflated condition. A tire carcass TCR having a plurality of layers or plies PL1-3 is shown as being disposed circumferentially about tire building drum 502 of a tire assembly machine 500. A portion 534 of tire building drum 502 extends radially outwardly beyond support assembly 504 with tire carcass TCR dimensioned to receive a bead core BCR. It will be recognized and appreciated that at least a portion of plies PL1-3 are disposed along an outer surface 536 of turnup bladder 526, and that such plies are typically in a green or otherwise uncured condition during a turnup operation. As such, at least a portion of one or more of plies PL1-3 may have a tendency to adhere to the outer surface of a turnup bladder under such conditions. Accordingly, in some cases, turnup bladder 526 can, optionally, include a release coating disposed on or along at least a portion of outer surface 536. As such, adhesion of the green plies to turnup bladder 526 can be minimized or at least reduced.

To complete a turnup operation, pressurized gas can be transferred into bladder chamber 532 of turnup bladder 526. As the pressurized gas is transferred into the bladder chamber, turnup bladder 526 begins to inflate and urges plies PL1-3 to engage a radially innermost edge of bead core BCR. As bladder chamber 532 further inflates, turnup bladder 526 assumes a somewhat toroidal shape, such as is shown in FIG. 9, for example, and plies PL1-3 are expanded outwardly around bead core BCR. In some cases, reciprocal support assembly 508 may be displaced from a distal position to a proximal position in which one or more of reciprocal support element 522 and/or bead-engaging element 524 abuttingly engage turnup bladder 526, such as to urge the turnup bladder and plies PL1-3 into a desired engagement with bead core BCR, for example.

Upon completion of the turnup process, reciprocal support assembly 508 can be returned to a distal position. Additionally, pressurized gas can be vented or otherwise transferred out of bladder chamber 532 to allow turnup bladder 526 to deflate to a toroidal contour and ultimately to a substantially uninflated state. It will be recognized and appreciated that during deflation, turnup bladder 526 pulls away from plies PL1-3. As such, the release coating, if included, can advantageously promote separation of the turnup bladder from the one or more tire plies. Additionally, such a release coating may also reduce wear on the turnup bladder and/or plies during separation and/or otherwise throughout the turnup process.

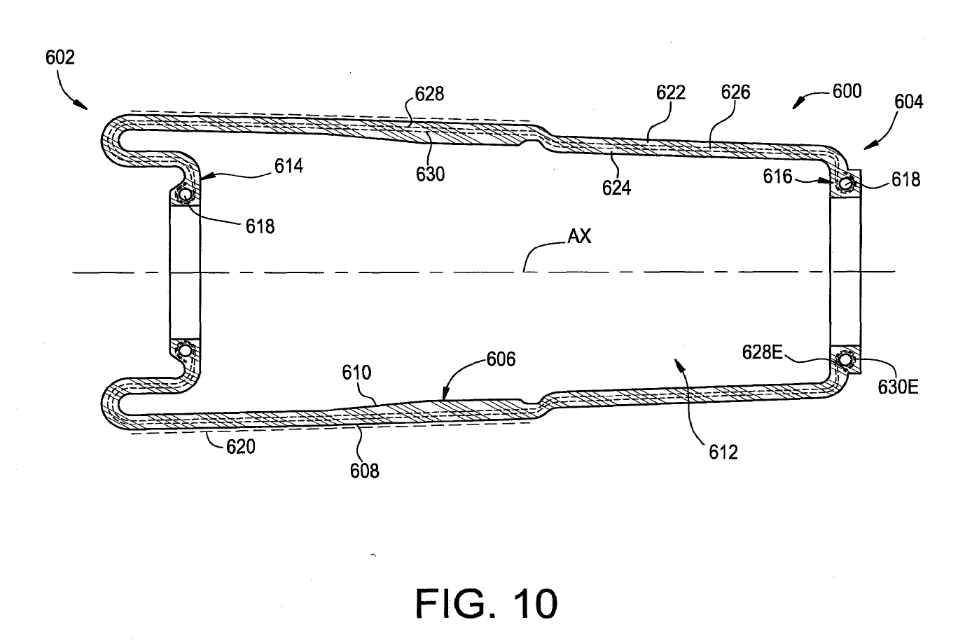

One example of a turnup bladder 600 in accordance with the subject matter of the present disclosure, such as may be suitable for use as turnup bladder 526 in FIG. 9, for example, is shown in FIG. 10 as having a longitudinally-extending axis AX. Turnup bladder 600 extends between opposing ends 602 and 604. Turnup bladder 600 includes a flexible wall 606 that extends peripherally about longitudinal axis AX and lengthwise between ends 602 and 604. Flexible wall 606 includes an outer surface 608 and an inner surface 610 such that a bladder chamber 612 can be at least partially defined by inner surface 610 of the flexible wall between ends 602 and 604.

Turnup bladder 600 can, optionally, include a mounting bead 614 (or other similar feature) disposed along end 602, and/or a mounting bead 616 (or other similar feature) along end 604. Mounting beads 614 and 616 can be used to secure the turnup bladder on or along an associated tire building machine or other apparatus, such as has been described above. As such, it will be appreciated that mounting beads 614 and/or 616 can have any suitable size, shape and/or configuration suitable for securement on or along the tire building machine, such as has been described above. Additionally, mounting beads 614 and/or 616 can, optionally, include one or more additional components and/or elements. For example, a substantially-inextensible, annular reinforcing element 618, which are commonly referred to as bead wires and/or bead cores, can optionally be at least partially embedded within one or more of the mounting beads. In the exemplary arrangement shown in FIG. 10, two reinforcing elements 618 are shown with one reinforcing element disposed along each of mounting beads 614 and 616.

Furthermore, in some cases, turnup bladder 600 can, optionally, include a release coating 620 disposed on or along at least a portion of outer surface 608 of flexible wall 606. In some cases, the release coating can extend over less than the full area of outer surface 608. For example, the release coating can extend longitudinally along the outer surface of the flexible wall over a distance that is less than the full longitudinal length of the flexible wall. As another example, the release coating can extend peripherally around the outer surface of the flexible wall over a distance that is less than the full periphery of the flexible wall. As such, the release coating can be disposed on or along the outer surface of the flexible wall in any suitable pattern or configuration of one or more areas or sections of coating material. Additionally, turnup bladder 600 can include any suitable number of one or more coating layers, which one or more coating layers can include release coating 620.

Flexible wall 606 can be constructed in any suitable manner and from any suitable material or combination of materials, such as by using one or more reinforcing plies or layers and zero or more un-reinforced, elastomeric plies or layers, for example. Typically, one or more reinforcing plies and one or more un-reinforced, elastomeric plies will be used together and formed from a common elastomeric material, such as a synthetic rubber, a natural rubber or a thermoplastic elastomer. In other cases, however, a combination of two or more different materials, two or more compounds of similar materials, or two or more grades of the same material could be used.

Flexible wall 606 can extend in a generally longitudinal direction between opposing ends 602 and 604. Additionally, flexible wall 606 can include an outer or cover ply 622 that at least partially forms outer surface 608, and inner or liner ply 624 that at least partially forms inner surface 610. In some cases, flexible wall 606 can, optionally, include an intermediate or spacer ply 626 disposed between the outer and inner plies.

In accordance with the subject matter of the present disclosure, flexible wall 606 further includes one or more reinforcing plies disposed between outer and inner surfaces 608 and 610. The one or more reinforcing plies can include a plurality of reinforcing elements that are embedded within the flexible wall in a non-linear pattern, such as is described hereinafter in greater detail. In some cases, two or more reinforcing plies can be used. In the arrangement shown in FIG. 10, for example, reinforcing plies 628 and 630, in accordance with the subject matter of the present disclosure, are shown as extending along flexible wall 606 and being substantially entirely embedded within the elastomeric material thereof, such as between adjacent ones of cover ply 622, spacer ply 626 and liner ply 624, for example. In some cases, one or more of the reinforcing plies and the plurality of the reinforcing elements thereof can be anchored or secured within the mounting bead. For example, ply ends 628E and 630E are shown in FIG. 10 as extending through and at least partially wrapping around annular reinforcing elements 618. It will be appreciated that other configurations and/or arrangements could alternately be used.

It will be appreciated that the reinforcing elements of the reinforcing plies will extend in a lengthwise direction, and that the one or more reinforcing plies can be oriented in any suitable manner relative to longitudinal axis AX, relative to one another and/or relative to other features of turnup bladder 600. As one example, the flexible wall can include at least one reinforcing layer or ply with reinforcing elements oriented in an approximately axial direction. As another example, the flexible wall can include at least one reinforcing layer or ply with reinforcing elements oriented lengthwise at one bias angle relative to axis AX, and at least one reinforcing layer or ply with reinforcing elements oriented lengthwise at another bias angle. In some cases, the two bias angles can be approximately equal but oriented opposite one another relative to axis AX.

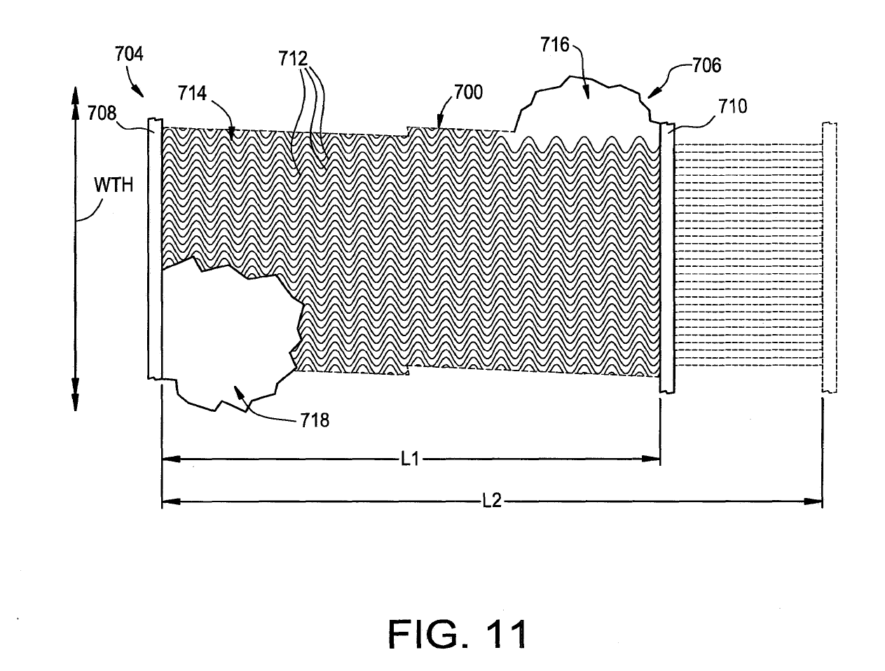

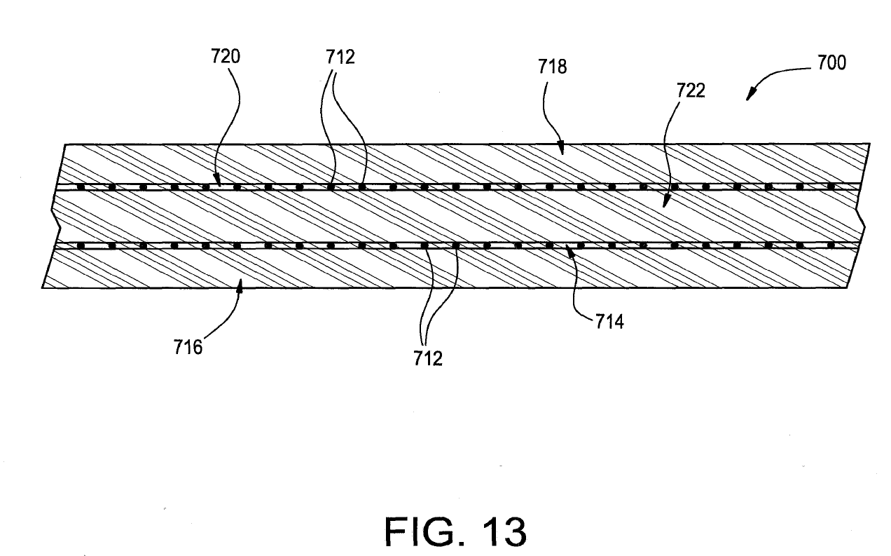

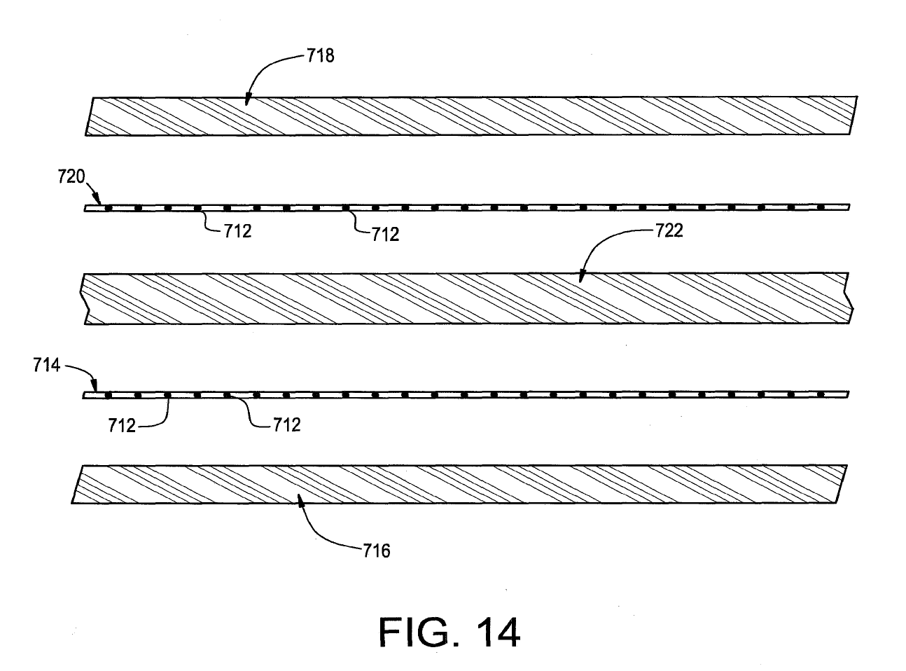

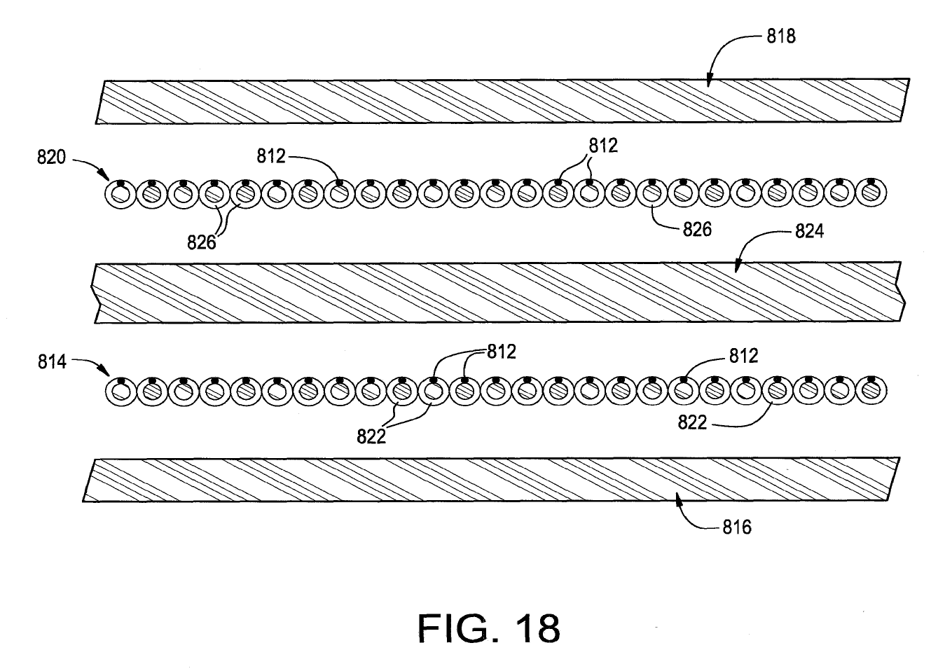

Exemplary elastomeric articles in accordance with the subject matter of the present disclosure, such as tire 220, flexible spring members 306 and 406, and turnup bladders 526 and 600, have been described above as including one or more reinforcing layers or plies with a plurality of reinforcing elements that are disposed in a non-linear, repeating pattern. FIGS. 11-20 illustrate examples of flexible wall constructions and reinforcing layer arrangements that are suitable for use in forming such elastomeric articles. Accordingly, it will be recognized and appreciated that the flexible wall constructions as well as the reinforcing layers or plies and the reinforcing elements thereof shown and described in connection with FIGS. 11-20 are to be interpreted as being applicable to any elastomeric articles in accordance with the subject matter of the present disclosure, such as any one or more of tire 220, flexible spring members 306 and 406, and turnup bladders 526 and 600, for example, as if specifically shown and described herein in connection therewith.

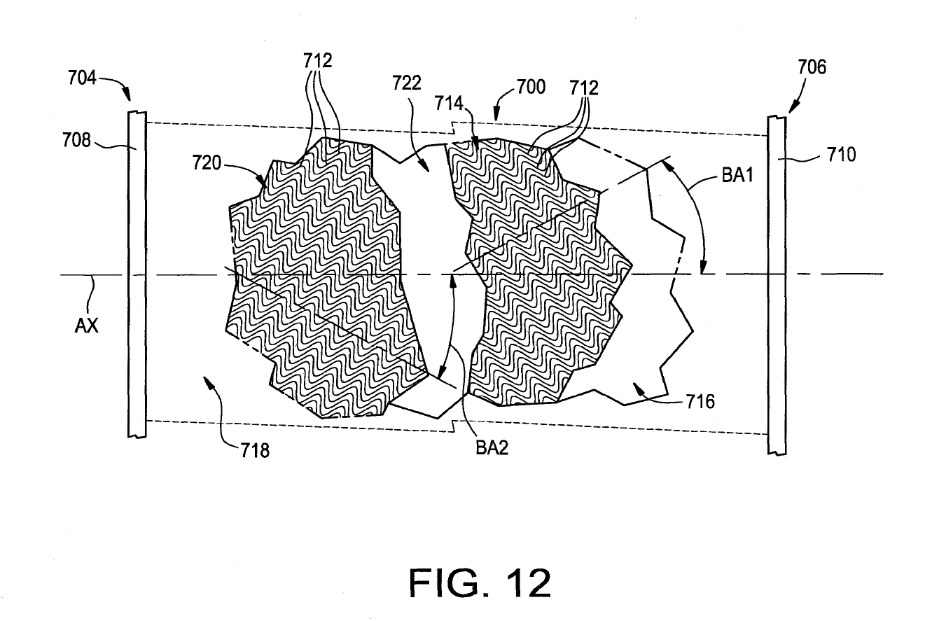

With reference to FIG. 11, a section of flexible wall 700 is shown as including a first layer of elastomeric material and as having an indefinite width, as is represented in FIG. 11 by dimension WTH. The section of flexible wall can also include a second layer of elastomeric material that together with the first layer could encapsulate the reinforcing elements of the flexible wall. Flexible wall 700 includes a first end 704 and a second end 706, and extends in a lengthwise direction between the first and second ends. Flexible wall 700 can optionally include one or more additional components. For example, annular reinforcing elements or bead wires are represented in FIGS. 11 and 12 as being disposed along first and second ends 704 and 706 by elements 708 and 710, which can be representative of any one or more of annular reinforcing elements 238, 382, 438 and/or 618.

A plurality of reinforcing elements 712 extend lengthwise along a surface of elastomeric material between first end 704 and second end 706. Reinforcing elements 712 are shown as being positioned adjacent one another in the widthwise direction. Additionally, reinforcing elements 712 are shown as extending along a path in the lengthwise direction that has a non-linear configuration. That is, reinforcing elements 712 are disposed in a repeating pattern along at least a portion of the length thereof. Examples of suitable repeating patterns that result in reinforcing elements having a non-linear configuration can include patterns with a sinusoidal shape, a zig-zag shape and/or other shapes which result in the reinforcing elements repeatedly crossing back-and-forth across a theoretical centerline of the pattern of the individual reinforcing element. In some cases, the centerline may have a relation to a linear axis ro plane of the individual reinforcing element.

Flexible wall 700 extends lengthwise between first and second ends 704 and 706. As such, flexible wall 700 is shown in FIG. 11 as having a free length, which is represented by dimension L1, and corresponds to a first or unloaded condition of the flexible wall. It will be appreciated that by arranging reinforcing elements 712 in flexible wall 700 in a non-linear configuration, the reinforcing elements will have a substantially greater length embedded within the flexible wall than the corresponding free length of the flexible wall. This additional length of the reinforcing elements will permit flexible wall 700 to stretch, expand and/or elongate to a greater extent than is generally possible with conventional constructions. As such, flexible wall 700 is shown in FIG. 11 as having an elongated length represented by dimension L2 in which second end 706 is displaced in the lengthwise direction relative to first end 704. This state can correspond to a second, inflated or otherwise loaded condition of the flexible wall It will be recognized and appreciated that under such elongated conditions, reinforcing elements 712 are drawn closer to a linear configuration with the amplitude or height of the repeating pattern being reduced. Thus, an increased elongation of flexible wall 700 can be achieved relative to conventional constructions in which the reinforcing material typically has limited elasticity or stretch.

It will be appreciated that reinforcing elements 712 can form one or more reinforcing layers or plies 714. In the arrangement shown in FIG. 11, reinforcing plies 714 and reinforcing elements 712 thereof are oriented in a generally lengthwise direction. In such an arrangement, one or more reinforcing plies 714 can be encapsulated between a first layer or ply 716 and a second layer or ply 718 that are, in a preferred arrangement, at least partially formed from unreinforced elastomeric material.

An alternate construction is shown in FIGS. 12-14 in which flexible wall 700 includes a plurality of reinforcing plies 714 and 720. In such a construction, reinforcing plies 714 and 720 can be substantially identical to one another. In many cases, however, the reinforcing elements of reinforcing plies 714 and 720 can be oriented at an acute angle relative to an axis or midplane, relative to one another and/or relative to one or more other features of the flexible wall. In the arrangement shown in FIG. 12, for example, reinforcing elements 712 of reinforcing ply 714 are disposed at a first bias angle BA1 relative to a reference line or axis AX and the reinforcing elements of reinforcing ply 720 are disposed at a second bias angle BA2 relative to axis AX. It will be appreciated that any suitable bias angles can be used, such as bias angles within a range of from approximately 3 degrees to approximately 60 degrees, for example. In some cases, the reinforcing elements can be disposed at approximately the same bias angle but oriented in opposing directions, such as is represented in FIG. 12 by reference dimensions BA1 and BA2, for example.

In some cases, reinforcing plies 714 and 720 can have an indefinite length or width. In which case, reinforcing ply material can be manufactured in bulk and sections of reinforcing ply material can be cut to an appropriate size for assembly. In such cases, two sections of reinforcing ply material could be positioned together between first and second plies 716 and 718 prior to encapsulation of the reinforcing plies between the unreinforced elastomeric plies.

As an alternate method of assembly, first ply 716 could be provided and a first plurality of reinforcing elements 712 could be deposited adjacent one another along a surface thereof in a non-linear pattern, as discussed above, to form reinforcing layer 714. An intermediate or spacer ply 722 of unreinforced elastomeric material could be positioned on first ply 716 overtop of reinforcing elements 712. A second plurality of reinforcing elements 712 could be deposited adjacent one another along a surface of the spacer ply in a non-linear pattern, as discussed above, to form reinforcing layer 720. Second ply 718 could be positioned on spacer ply 722 overtop of reinforcing elements 712. In a preferred arrangement, at least the unreinforced layers of elastomeric material are provided in an uncured condition such that the construction can subsequently be cured to substantially encapsulate the one or more reinforcing plies within the flexible wall.

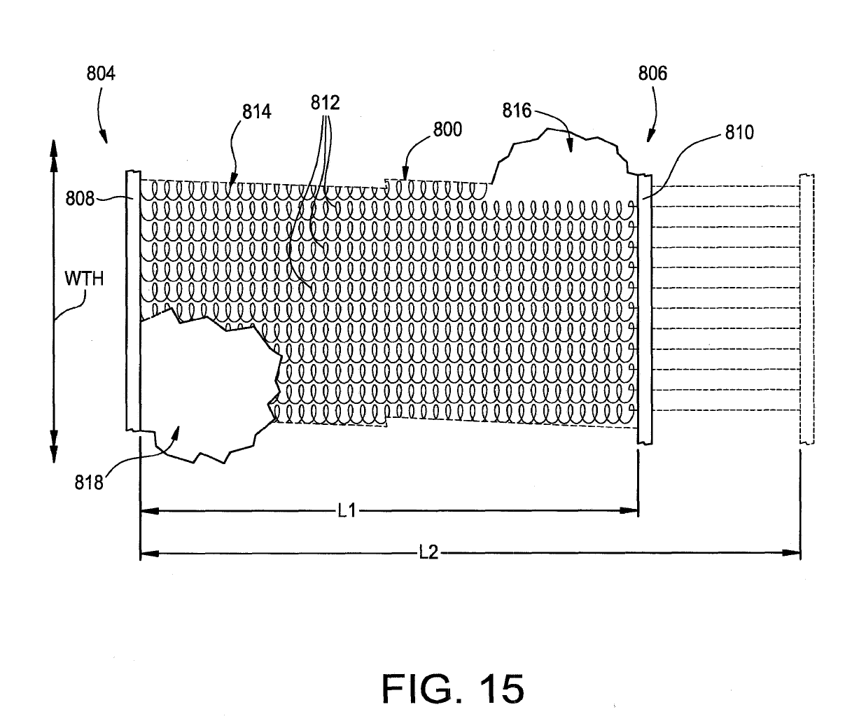

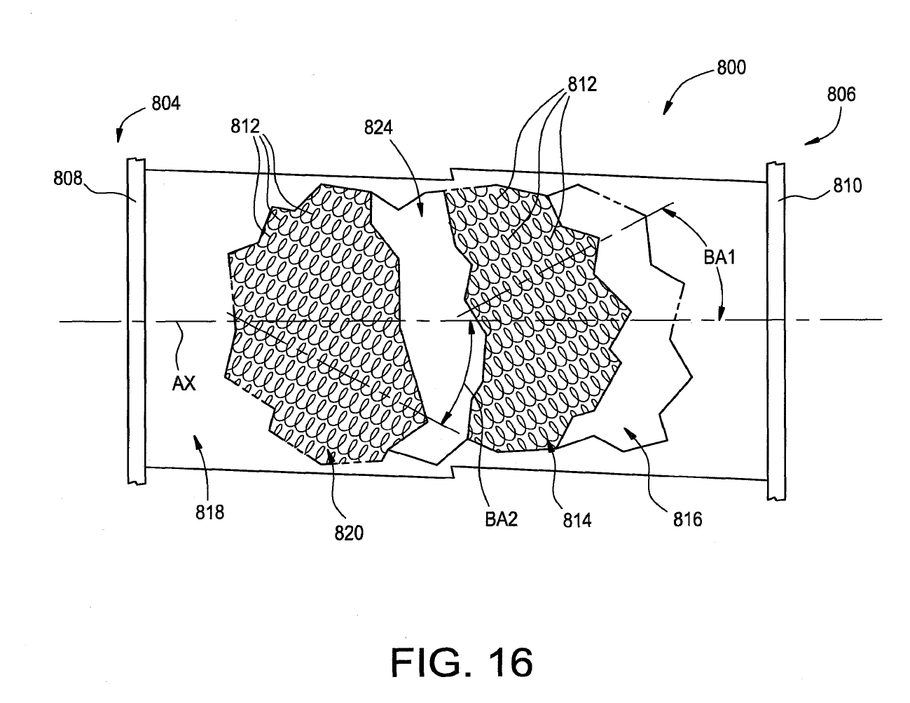

With reference to FIG. 15, a section of flexible wall 800 is shown as including a first layer of elastomeric material 802 and as having an indefinite width, as is represented in FIG. 15 by dimension WTH. The section of flexible wall can also include a second layer of elastomeric material that together with the first layer could encapsulate the reinforcing elements of the flexible wall. Flexible wall 800 includes a first end 804 and a second end 806, and extends in a lengthwise direction between the first and second ends. Flexible wall 800 can optionally include one or more additional components. For example, annular reinforcing elements or bead wires are represented in FIGS. 15 and 16 as being disposed along first and second ends 804 and 806 by elements 808 and 810, which can be representative of any one or more of annular reinforcing elements 238, 382, 438 and/or 618.

A plurality of reinforcing elements 812 extend lengthwise along a surface of elastomeric material between first end 804 and second end 806. Reinforcing elements 812 are shown as being positioned adjacent one another in the widthwise direction. Additionally, reinforcing elements 812 are shown as extending along a path in the lengthwise direction that has a non-linear configuration. That is, reinforcing elements 812 are disposed in a helical arrangement along at least a portion of the length thereof in which at least a portion of a reinforcing element is extends helically about a theoretical axis of rotation. In some cases, the axis of rotation could extend in a generally linear direction. In other cases, the axis of rotation could extend in a curved, helical or other non-linear arrangement.

Flexible wall 800 extends lengthwise between first and second ends 804 and 806. As such, flexible wall 800 is shown in FIG. 15 as having a free length, which is represented by dimension L1, and corresponds to a first or unloaded condition of the flexible wall. It will be appreciated that by arranging reinforcing elements 812 in flexible wall 800 in a non-linear configuration, the reinforcing elements will have a substantially greater length embedded within the flexible wall than the corresponding free length of the flexible wall. This additional length of the reinforcing elements will permit flexible wall 800 to stretch, expand and/or elongate to a greater extent than is generally possible with conventional constructions. As such, flexible wall 800 is shown in FIG. 15 as having an elongated length represented by dimension L2 in which second end 806 is displaced in the lengthwise direction relative to first end 804. It will be recognized and appreciated that under such elongated conditions, reinforcing elements 812 are drawn closer to a linear configuration with a radial dimension of the helix being reduced and/or the distance between adjacent loops of the helical arrangement being increased. Thus, an increased elongation of flexible wall 800 can be achieved relative to conventional constructions in which the reinforcing material typically has limited elasticity or stretch.

It will be appreciated that reinforcing elements 812 can form one or more reinforcing layers or plies 814. In the arrangement shown in FIG. 15, reinforcing plies 814 and reinforcing elements 812 thereof are oriented in a generally lengthwise direction. In such an arrangement, one or more reinforcing plies 814 can be encapsulated between a first layer or ply 816 and a second layer or ply 818 that are, in a preferred arrangement, formed from unreinforced elastomeric material.

An alternate construction is shown in FIGS. 16-18 in which flexible wall 800 includes a plurality of reinforcing plies 814 and 820. In such a construction, reinforcing plies 814 and 820 can be substantially identical to one another. In many cases, however, the reinforcing elements of reinforcing plies 814 and 820 can be oriented at an acute angle relative to an axis or midplane, relative to one another and/or relative to one or more other features of the flexible wall. In the arrangement shown in FIG. 16, for example, reinforcing elements 812 of reinforcing ply 814 are disposed at a first bias angle BA1 relative to a reference line or axis AX and the reinforcing elements of reinforcing ply 820 are disposed at a second bias angle BA2 relative to axis AX. It will be appreciated that any suitable bias angles can be used, such as bias angles within a range of from approximately 3 degrees to approximately 60 degrees, for example. In some cases, the reinforcing elements can be disposed at approximately the same bias angle but oriented in opposing directions, such as is represented in FIG. 16 by reference dimensions BA1 and BA2, for example.

In some cases, reinforcing plies 814 and 820 can have an indefinite length or width. In which case, reinforcing ply material can be manufactured in bulk and sections of reinforcing ply material can be cut to an appropriate size for assembly. In such cases, two sections of reinforcing ply material could be positioned together between first and second plies 816 and 818 prior to encapsulation of the reinforcing plies between the unreinforced elastomeric plies.

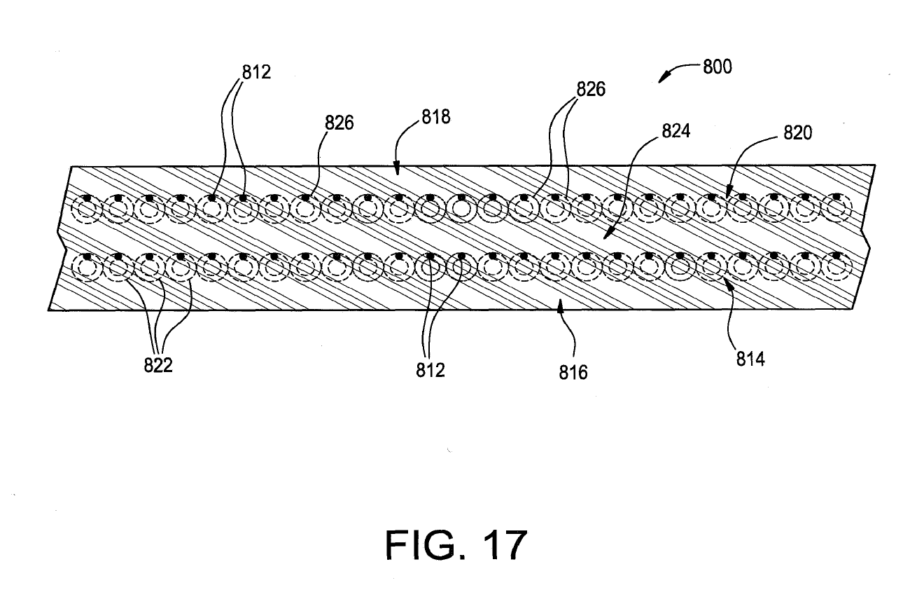

As an alternate method of assembly, first ply 816 could be provided and a first plurality of reinforcing element and core assemblies 822 (FIGS. 17-20) could be deposited adjacent one another along a surface thereof to form reinforcing layer 814. An intermediate or spacer ply 824 of unreinforced elastomeric material could be positioned on first ply 816 overtop of assemblies 822. A second plurality of reinforcing element and core assemblies 826 (FIGS. 17-20) could be deposited adjacent one another along a surface of the spacer ply to form reinforcing layer 820. Second ply 818 could be positioned on spacer ply 824 overtop of assemblies 826. In a preferred arrangement, at least the unreinforced layers of elastomeric material are provided in an uncured condition such that the construction can subsequently be cured to substantially encapsulate the one or more reinforcing plies within the flexible wall.

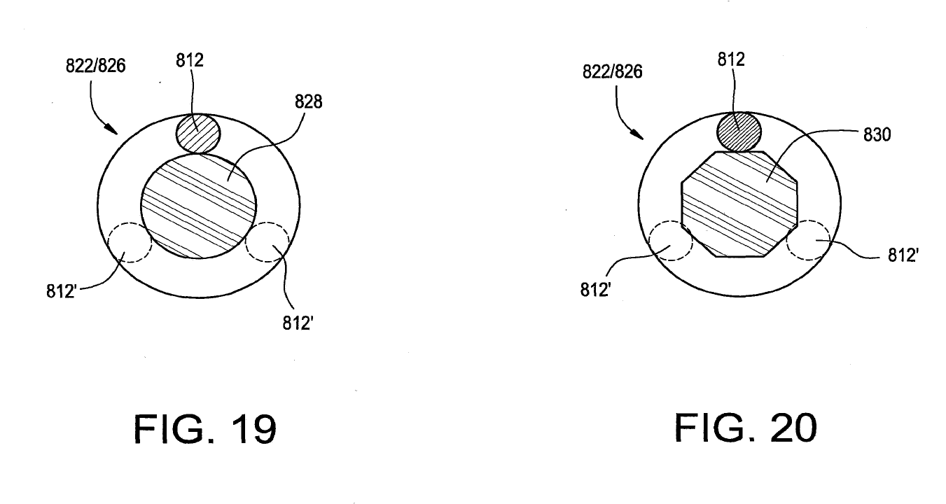

FIG. 19 illustrates one example of a suitable construction for reinforcing element and core assemblies 822 and/or 826. One method for forming a reinforcing element with a helical shape is to wind, wrap or otherwise extend reinforcing elements 812 around a core that is formed from an unreinforced elastomeric material. It will be appreciated that such a core can be of an elongated length and can be of a suitable size and shape to permit one or more reinforcing elements to extend in a generally uniform manner around the core. One example of a core 828 is shown in FIG. 19 as having a generally circular cross-sectional shape. Another example of a core 830 is shown in FIG. 20 as having a polygonal shape. In some cases, two or more reinforcing element could be helically extended about the core, such as are represented in FIGS. 19 and 20 by additional reinforcing elements 812′. In a preferred arrangement, cores 828 and/or 830 can be formed from an uncured elastomeric material such that upon assembly with the other unreinforced plies of the flexible wall, the core material can cure together with the other unreinforced plies to substantially encapsulate reinforcing elements 812 and/or 812′ within flexible wall 800.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood that claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. An elastomeric article comprising:
an elastomeric body at least partially formed from an elastomeric material, said elastomeric body including a first surface portion and a second surface portion opposite said first surface portion; and,
a first plurality of reinforcing elements embedded within said elastomeric body between said first and second surface portions, said first plurality of reinforcing elements having a first end and a second end opposite said first end with said first plurality of reinforcing elements having a non-linear pattern formed therealong between said first and second ends thereof.

2. An elastomeric article according to claim 1, wherein said non-linear pattern of said first plurality of reinforcing elements is a repeating pattern having an approximately sinusoidal shape.

3. An elastomeric article according to claim 1, wherein said non-linear pattern of said first plurality of reinforcing elements has an approximately helical shape extending around an element axis.

4. An elastomeric article according to claim 3, wherein two or more of said first plurality of reinforcing elements extend around said element axis.

5. An elastomeric article according to claim 1, wherein said first plurality of reinforcing elements are disposed in a first reinforcing layer within said elastomeric body.

6. An elastomeric article according to claim 1 further comprising:
a second plurality of reinforcing elements embedded within said elastomeric body between said first and second surface portions in spaced relation to said first plurality of reinforcing elements, said second plurality of reinforcing elements having a first end and a second end opposite said first end with said second plurality of reinforcing elements having a non-linear pattern formed therealong between said first and second ends thereof.

7. An elastomeric article according to claim 6, wherein said non-linear pattern of said second plurality of reinforcing elements is a repeating pattern having an approximately sinusoidal shape.

8. An elastomeric article according to claim 6, wherein said non-linear pattern of said second plurality of reinforcing elements has an approximately helical shape extending around an element axis.

9. An elastomeric article according to claim 8, wherein two or more of said second plurality of reinforcing elements extend around said element axis.

10. An elastomeric article according to claim 6, wherein said first plurality of reinforcing elements are disposed in a first reinforcing layer within said elastomeric body, and said second plurality of reinforcing elements are disposed in a second reinforcing layer within said elastomeric body spaced apart from said first reinforcing layer.

11. An elastomeric article according to claim 1, wherein said elastomeric body includes an axis, and said first plurality of reinforcing elements extend along said elastomeric body in approximate alignment with said axis.

12. An elastomeric article according to claim 1, wherein said elastomeric body includes an axis, and said first plurality of reinforcing elements extend along said elastomeric body at a first acute angle relative to said axis.

13. An elastomeric article according to claim 12, wherein said second plurality of reinforcing elements extend along said elastomeric body at a second acute angle relative to said axis.

14. (canceled)

15. An elastomeric article according to claim 1, wherein said elastomeric body includes an axis of rotation, a crown portion extending peripherally about said axis and lengthwise in a generally axial direction, first and second sidewalls disposed in axially-spaced relation to one another and extending radially inwardly from along said crown portion to respective first and second bead areas with said first surface portion extending along at least said crown portion and said first and second sidewalls to form an annular cavity within said elastomeric body.

16. An elastomeric article according to claim 15 further comprising a first bead reinforcing element embedded within said first bead area and a second bead reinforcing element embedded within said second bead area with at least said first plurality of reinforcing elements extending between and operatively secured to said first and second bead reinforcing elements.

17. An elastomeric article according to claim 15 further comprising:
one or more belts extending peripherally along said crown portion radially outward of at least said first plurality of reinforcing elements; and,
a tread extending peripherally about said axis radially outward of said one or more belts.

18. An elastomeric article according to claim 1, wherein said elastomeric body has a longitudinal axis, and said elastomeric body extends peripherally about said longitudinal axis and longitudinally between a first end and a second end opposite said first end with said first surface portion at least partially defining a chamber within said elastomeric body.

19. An elastomeric article according to claim 18, wherein said elastomeric body includes a first mounting bead formed along said first end and a second mounting bead formed along said second end with a first bead reinforcing element embedded within said first end and a second bead reinforcing element embedded within said second end and at least said first plurality of reinforcing elements extending between and operatively secured to said first and second bead reinforcing elements.

20. An elastomeric article according to claim 18, wherein said first end at least partially defines a first opening and said second end at least partially defines a second opening with at least one of said first and second openings dimensioned for securement to an associated tire building machine.

21. An elastomeric article according to claim 18 further comprising a first end member secured in a substantially fluid-tight manner to said first end of said elastomeric body and a second end member secured in a substantially fluid-tight manner to said second end of said elastomeric body such that a spring chamber is at least partially defined by said elastomeric body between said first and second end members.

22.-33. (canceled)
